(19) United States
(12) Patent Application Publication
(10) Pub. No.: US 2019/0261577 A1
(43) Pub. Date: Aug. 29, 2019

(54) MOBILE AGRICULTURE

(71) Applicant: GEREK LEVI BURFORD, PRESCOTT VALLEY, AZ (US)

(72) Inventor: GEREK LEVI BURFORD, PRESCOTT VALLEY, AZ (US)

(21) Appl. No.: 15/904,357

(22) Filed: Feb. 24, 2018

(51) Int. Cl. A01G 9/02; A01G 31/02

(52) U.S. Cl. CPC A01G 9/02; A01G 31/02

(57) ABSTRACT

An apparatus comprising of a component used in agriculture or cultivation that utilizes a device, such as wheels, rollers, bearings etc. . . . , to assist in the free range mobility of the component. Further the apparatus comprising of a component used in agriculture or cultivation that may also contain devices, such as quick connected couplers with internal valves, fittings, tubing etc. . . . , to couple and un-couple the components if multiple components are used in conjunction with one another and links to connect components if one component is removed from a series of components. This apparatus increases efficiency. This is achieved by allowing the free range mobility of the component used in agriculture or cultivation and the coupling and un-coupling of the component. The benefit of this is to allow the process to achieve an assembly line approach rather than a stationary single point approach.

### CROSS-REFERENCE TO RELATED APPLICATIONS

### Industrial Aeroponics

Application Ser. No. 62462922

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### STATEMENT REGARDING PRIOR DISCLOSURES BY THE INVENTOR OR A JOINT INVENTOR

Not applicable

### BACKGROUND OF THE INVENTION

### 1) Field of the Invention

The subsequent invention is a method in the technical field of agriculture. More specifically the subsequent invention is in the technical field of traditional agriculture, hydroponics, aquaponics, and aeroponics.

### 2) Description of Related Art including information disclosed under 37 CFR 1.97 and 1.98.

### 2) Description of Related Art including information disclosed under 37 CFR 1.97 and 1.98.

| Pat. No. | Title |
|---|---|
| U.S. Pat. No. 9,856,489 | Method for producing high-quality recombinant |
| | allergens in a plant |
| U.S. Pat. No. 9,848,545 | Growing systems and methods |
| U.S. Pat. No. 9,814,186 | Growing system |
| U.S. Pat. No. 9,810,673 | Cannabis cultivation test |
| U.S. Pat. No. 9,807,949 | Root environment control system and method |
| U.S. Pat. No. 9,803,222 | Processing biomass |
| U.S. Pat. No. 9,788,495 | Vertical aeroponic plant growing enclosure |
| U.S. Pat. No. 9,780,252 | Method and apparatus for reduction of solar cell |
| | LID |
| U.S. Pat. No. 9,745,609 | Processing biomass |
| U.S. Pat. No. 9,745,604 | Processing biomass |
| U.S. Pat. No. 9,743,665 | Fungicidal 3-{phenyl[heterocyclylmethoxy) |
| | imino]methyl}-oxadiazolone derivatives |
| U.S. Pat. No. 9,743,597 | Hydroponic rotating drum device for interiorly |
| | rooting and exteriorly growing plants |
| D795,130 | Aeroponic crop tower |
| U.S. Pat. No. 9,739,430 | Systems, methods and/or devices for providing |
| | LED lighting |
| U.S. Pat. No. 9,738,567 | Soluble fertilizer formulation and method |
| | for use thereof |
| U.S. Pat. No. 9,693,512 | Wireless sensor systems for hydroponics |
| U.S. Pat. No. 9,681,504 | Driver circuits with multiple rectifiers |
| U.S. Pat. No. 9,677,040 | Systems and methods of improved fermentation |
| U.S. Pat. No. 9,668,434 | Root misting system |
| U.S. Pat. No. 9,655,309 | Rooftop greenhouse inside roof infrastructure |
| U.S. Pat. No. 9,648,811 | Sequential and cyclic aeroponic system |
| U.S. Pat. No. 9,643,895 | Nutrient rich compositions |
| U.S. Pat. No. 9,642,370 | Bacteria and method for improving plant |
| | health and growth |
| U.S. Pat. No. 9,622,427 | Hydroponic system for growing plants |
| U.S. Pat. No. 9,622,426 | Method of improving the growth and |
| | production output of plants of the family |
| | Cannabaceae sensu stricto |
| U.S. Pat. No. 9,606,553 | SanSSoil (soil-less) indoor farming for food |
| | and energy production |
| U.S. Pat. No. 9,605,288 | Processing biomass |
| U.S. Pat. No. 9,605,287 | Processing biomass |
| U.S. Pat. No. 9,591,814 | Light-weight modular adjustable vertical |
| | hydroponic growing system and method |
| U.S. Pat. No. 9,587,258 | Processing biomass |
| U.S. Pat. No. 9,578,819 | Pressurized growing air system for vertical and |
| | horizontal planting systems |
| U.S. Pat. No. 9,568,458 | Optical sensor for fluid analysis |
| U.S. Pat. No. 9,565,812 | LED light timing in a high growth, high density, |
| | closed environment system |
| U.S. Pat. No. 9,556,158 | Fungicidal 3-[(pyridin-2-ylmethoxyimino) |
| | (phenyl)methyl]-2-substituted-1,2,-4-oxadiazol- |
| | 5(2H)-one derivatives |
| U.S. Pat. No. 9,532,518 | Hydroponic growing system |
| U.S. Pat. No. 9,516,822 | Modular automated aeroponic growth system |
| U.S. Pat. No. 9,510,524 | Irrigation system |
| U.S. Pat. No. 9,491,915 | Vertical hydroponic plant production apparatus |
| U.S. Pat. No. 9,474,273 | Composition comprising an elicitor of the plant |
| | immune system |
| U.S. Pat. No. 9,474,217 | Controlled environment and method |
| U.S. Pat. No. 9,456,689 | Plant growing heavy weight bearing support |
| | assembly, apparatus and system |
| U.S. Pat. No. 9,439,989 | Disinfecting light fixture |
| U.S. Pat. No. 9,439,436 | Use of aryl carbamates in agriculture and other |
| | plant-related areas |
| U.S. Pat. No. 9,439,386 | Lettuce variety NUN 09051 LTL |
| U.S. Pat. No. 9,433,695 | Systems, apparatus, methods and articles |
| | for use in sanitization or disinfection |
| U.S. Pat. No. 9,433,160 | Hydroponic array for the individualized |
| | delivery of nutrients |
| U.S. Pat. No. 9,416,062 | Nutrient rich compositions |
| U.S. Pat. No. 9,410,258 | Systems and methods of improved fermentation |
| U.S. Pat. No. 9,408,391 | Fungicide composition comprising a |
| | tetrazolyloxime derivative and a |
| | thiazolylpiperidine derivative |
| U.S. Pat. No. 9,408,385 | Pesticidal composition comprising a |
| | pyridylethylbenzamide derivative and an |
| | insecticide compound |
| U.S. Pat. No. 9,382,633 | Systems and methods of improved fermentation |
| U.S. Pat. No. 9,380,756 | Lettuce variety multigreen 50 |
| U.S. Pat. No. 9,380,751 | Vertical hydroponic plant production apparatus |
| U.S. Pat. No. 9,375,010 | Fungicidal 3-{phenyl[(heterocyclylmethoxy) |
| | imino]methyl}-oxadiazolone derivatives |
| U.S. Pat. No. 9,374,953 | Vertical aeroponic plant growing enclosure |
| | with support structure |
| U.S. Pat. No. 9,359,265 | Plant nutrient coated nanoparticles and |
| | methods for their preparation and use |
| U.S. Pat. No. 9,357,715 | Vertical planter |
| U.S. Pat. No. 9,357,714 | Method for cultivating plants as well as a |
| | floating carrier |
| U.S. Pat. No. 9,345,207 | Commercial aeroponics system |
| U.S. Pat. No. 9,333,274 | Disinfecting light fixture |
| U.S. Pat. No. 9,326,515 | Fungicidal 3-[(1,3-thiazol-4-ylmethoxyimino) |
| | (phenyl)methyl]-2-substituted--1,2,4- |
| | oxadiazol-5(2H)-one derivatives |
| U.S. Pat. No. 9,309,545 | Processing biomass |
| U.S. Pat. No. 9,297,021 | MtNIP regulated plants with significantly |
| | increased size and biomass |
| U.S. Pat. No. 9,288,951 | Method and apparatus for aeroponic growth |
| U.S. Pat. No. 9,282,699 | Irrigation system |
| U.S. Pat. No. 9,279,101 | Systems and methods of improved fermentation |
| U.S. Pat. No. 9,259,771 | Methods of using hydrogen peroxide for |
| | in-situ chemical oxidation treatment |
| | of soil and groundwater |
| U.S. Pat. No. 9,247,688 | Nutrient blend optimization system |
| U.S. Pat. No. 9,241,454 | Lipochito-oligosaccharides stimulating |
| | arbuscular mycorrhizal symbiosis |
| U.S. Pat. No. 9,241,453 | Aeroponic commercial plant cultivation |
| | system utilizing a grow enclosure |
| U.S. Pat. No. 9,220,207 | Hydroponic produce display apparatus |
| U.S. Pat. No. 9,210,935 | Pesticide composition comprising fosetyl- |
| | aluminium, propamocarb-HCl and an |
| | insecticide active substance |
| U.S. Pat. No. 9,210,910 | Lettuce variety multired 54 |
| U.S. Pat. No. 9,210,846 | Vertical concentrated vegetable and plant |
| | grower |
| U.S. Pat. No. 9,198,396 | Lettuce variety NUN 06075 LTL |
| U.S. Pat. No. 9,198,395 | Lettuce variety multigreen 57 LTL |
| U.S. Pat. No. 9,175,258 | Microbial compositions and methods |
| U.S. Pat. No. 9,161,541 | Pesticide composition comprising |
| | propamocarb-hydrochloride and an |
| | insecticide active substance |
| U.S. Pat. No. 9,149,006 | Garden made EZ modular planter device |
| U.S. Pat. No. 9,144,223 | Lettuce variety multigreen 60 |
| U.S. Pat. No. 9,144,206 | Soil-free cultivation system |
| U.S. Pat. No. 9,131,685 | Compositions comprising a strigolactone |
| | compound and a chito-oligosaccharide |
| | compound for enhanced plant growth and yield |
| U.S. Pat. No. 9,127,244 | Digester assembly for providing renewable |
| | resource sand associated systems, |
| | apparatuses, and methods |
| U.S. Pat. No. 9,125,417 | Pesticide composition comprising fosetyl- |
| | aluminium, propamocarb-HCl |
| | and an insecticide active substance |
| U.S. Pat. No. 9,125,408 | Use of aryl carbamates in agriculture and |
| | other plant-related areas |
| U.S. Pat. No. 9,125,351 | Plant cultivation device |
| U.S. Pat. No. 9,113,606 | Growing system for hydroponics and/or |
| | aeroponics |
| U.S. Pat. No. 9,090,600 | Fungicidal 4-substituted-3-{phenyl |
| | [(heterocyclylmethoxy)imino] |
| | methyl}-1,2,-4-oxadizol-5(4H)-one derivatives |
| U.S. Pat. No. 9,078,461 | Processing biomass |
| U.S. Pat. No. 9,067,840 | Organic plant nutrient |
| U.S. Pat. No. 9,060,518 | Pesticide composition comprising a |
| | tetrazolyloxime derivative and a fungicide or |
| | an insecticide active substance |
| U.S. Pat. No. 9,000,012 | Fungicide hydroximoyl-heterocycles |
| | derivatives |
| U.S. Pat. No. 8,984,807 | Method and apparatus for aeroponic growth |
| U.S. Pat. No. 8,981,111 | Fungicide hydroximoyl-heterocycles |
| | derivatives |
| U.S. Pat. No. 8,980,602 | Processing biomass |
| U.S. Pat. No. 8,969,392 | Pesticide composition comprising |
| | propamocarb-fosetylate and an insecticidally |
| | active substance |
| U.S. Pat. No. 8,927,583 | Pesticidal composition comprising a 2- |
| | pyrdilmethyl-benzamide derivative |
| | and an insecticide compound |
| U.S. Pat. No. 8,919,040 | Spiral garden |
| U.S. Pat. No. 8,919,038 | Irrigation system and method |
| U.S. Pat. No. 8,904,705 | Aeroponic system and sprayer device for |
| | improved plant growth and aeration |
| U.S. Pat. No. 8,881,454 | Agriculture production system with |
| | temperature controlled root zone |
| U.S. Pat. No. 8,877,684 | Pesticidal composition comprising a synthetic |
| | compound useful as nodulation agent of |
| | leguminous plants and an insecticide compound |
| U.S. Pat. No. 8,877,472 | Electron beam irradiation processing of |
| | biomass and saccharification thereof |
| U.S. Pat. No. 8,871,923 | Composition comprising an elicitor of the |
| | plant immune system |
| U.S. Pat. No. 8,851,457 | Low-turbulent aerator and aeration method |
| U.S. Pat. No. 8,841,101 | Processing biomass |
| U.S. Pat. No. 8,835,142 | Processing biomass |
| U.S. Pat. No. 8,796,512 | Lettuce variety multired 55 |
| U.S. Pat. No. 8,796,463 | Fungicide hydroximoyl-tetrazole derivatives |
| U.S. Pat. No. 8,785,729 | Lettuce variety redglace |
| U.S. Pat. No. 8,782,948 | Method and apparatus for aeroponic farming |
| U.S. Pat. No. 8,778,835 | Pesticidal composition comprising a |
| | pyridylethylbenzamide derivative and an |
| | insecticide compound |
| U.S. Pat. No. 8,765,452 | Flow tube reactor |
| U.S. Pat. No. 8,754,293 | Lettuce variety intred |
| U.S. Pat. No. 8,738,160 | Apparatus and method for plant metabolism |
| | manipulation using spectral output |
| U.S. Pat. No. 8,735,662 | Lettuce variety salmon |
| U.S. Pat. No. 8,728,779 | Processing biomass |
| U.S. Pat. No. 8,720,110 | Hydroponics equipment cleaning method |
| U.S. Pat. No. 8,637,284 | Processing biomass |
| U.S. Pat. No. 8,629,086 | Compositions and methods for the control of |
| | nematodes and soil borne diseases |
| U.S. Pat. No. 8,623,110 | Protein and isolated or purified amino acid |
| | product containing compositions |
| | and uses thereof |
| U.S. Pat. No. 8,621,782 | Mechanism for aeration and hydroponic |
| | growth of plant applications |
| U.S. Pat. No. 8,614,217 | Fungicide hydroximoyl-tetrazole derivatives |
| U.S. Pat. No. 8,580,799 | Fungicide hydroximoyl-heterocycles |
| | derivatives |
| U.S. Pat. No. 8,557,849 | Fungicide hydroximoyl-tetrazole derivatives |
| U.S. Pat. No. 8,544,207 | Hydroponic plant growth systems with |
| | activated carbon and/or carbonized |
| | fiber substrates |
| U.S. Pat. No. 8,533,993 | Modular vertical farm cell |
| U.S. Pat. No. 8,533,992 | Method and apparatus for aeroponic farming |
| U.S. Pat. No. 8,505,238 | Vertical aeroponic plant growing system |
| U.S. Pat. No. 8,492,388 | Fungicide hydroximoyl-tetrazole derivatives |
| U.S. Pat. No. 8,484,890 | Apparatus for aeroponically growing and |
| | developing plants |
| U.S. Pat. No. 8,468,741 | Semi-automated crop production system |
| U.S. Pat. No. 8,466,176 | Fungicide hydroximoyl-tetrazole derivatives |
| U.S. Pat. No. 8,443,546 | Hydroponic plant growing system |
| U.S. Pat. No. 8,440,591 | Pesticidal composition comprising synthetic |
| | compound useful as nodulation agent of |
| | leguminous plants and a fungicide compound |
| U.S. Pat. No. 8,418,401 | Photovoltaic greenhouse structure |
| U.S. Pat. No. 8,365,466 | Hydroponic produce display apparatus |
| U.S. Pat. No. 8,327,582 | Vertical hydroponic plant production apparatus |
| U.S. Pat. No. 8,324,177 | Triterpene compositions and methods |
| | for use thereof |
| U.S. Pat. No. 8,291,639 | Growing system for hydroponics and/or |
| | aeroponics |
| U.S. Pat. No. 8,288,426 | Pesticidal composition comprising |
| | fenamidone and an insecticide compound |
| U.S. Pat. No. 8,261,487 | Method and apparatus for growing plants |
| U.S. Pat. No. 8,261,486 | Systems and methods for controlling liquid |
| | delivery and distribution to plants |
| U.S. Pat. No. 8,256,382 | Method and system for managing animal |
| | waste in an animal breeding farm |
| U.S. Pat. No. 8,250,809 | Apparatus for aeroponically growing and |
| | developing plants |
| U.S. Pat. No. 8,236,830 | Pesticide composition comprising |
| | propamocarb-fosetylate and an insecticidally |
| | active substance |
| U.S. Pat. No. 8,225,549 | Apparatus for aeroponically growing and |
| | developing plants |
| U.S. Pat. No. 8,216,971 | Pesticide composition comprising |
| | propamocarb-hydrochloride and an insecticide |
| | active substance |
| U.S. Pat. No. 8,186,100 | Photovoltaic greenhouse structure |
| D658,537 | Vertical aeroponic growing tower |
| U.S. Pat. No. 8,122,643 | Method and apparatus for growing plants |
| U.S. Pat. No. 7,985,435 | Triterpene compositions and methods for use |
| | thereof |
| U.S. Pat. No. 7,966,767 | Enhanced plant growth using alkane |
| | biostimulation |
| U.S. Pat. No. 7,877,927 | Modular aeroponic/hydroponic container |
| | mountable to a surface |
| U.S. Pat. No. 7,842,264 | Process and apparatus for carbon capture and |
| | elimination of multi-pollutants in flue gas |
| | from hydrocarbon fuel sources and |
| | recovery of multiple by-products |
| U.S. Pat. No. 7,823,328 | Aeroponic plant growing system |
| U.S. Pat. No. 7,811,352 | Fertilizer compositions and methods of using |
| U.S. Pat. No. 7,776,124 | Fertilizer compositions and methods of using |
| U.S. Pat. No. 7,670,632 | Triterpene compositions and methods for use |
| | thereof |
| U.S. Pat. No. 7,641,132 | Dispersion and aeration apparatus for |
| | compressed air foam systems |
| U.S. Pat. No. 7,621,129 | Power generation system |
| D604,196 | Indoor gardening appliance |
| U.S. Pat. No. 7,426,802 | Seed germination and paint supporting utility |
| U.S. Pat. No. 7,350,331 | Method for producing metabolites from plants |
| | cultivated in soil-less medium |
| U.S. Pat. No. 7,328,532 | Method and a kit for shaping a portion of a |
| | woody plant into a desired form |
| U.S. Pat. No. 7,192,523 | Methods for treating agricultural waste and |
| | producing plant growth-enhancing material |
| U.S. Pat. No. 7,181,886 | Orbital hydroponic or aeroponic agricultural |
| | unit |
| U.S. Pat. No. 7,105,186 | Triterpene compositions and methods for use |
| | thereof |
| U.S. Pat. No. 7,057,023 | Methods and apparatus for spinning spider |
| | silk protein |
| U.S. Pat. No. 7,022,524 | Increasing plant growth with luminol |
| U.S. Pat. No. 6,962,720 | Triterpene compositions and methods for use |
| | thereof |
| U.S. Pat. No. 6,957,512 | Method for the propogation of and aeroponic |
| | growing of plants and vessels therefor |
| U.S. Pat. No. 6,849,777 | LNP, a protein involved in the initiation of |
| | mycorrhizal infection in plants |
| U.S. Pat. No. 6,837,002 | Tray for hydroponic and aeroponic cultivation |
| U.S. Pat. No. 6,807,770 | Low pressure aeroponic growing apparatus |
| U.S. Pat. No. 6,759,232 | Method of facilitating mass production and |
| | sporulation of arbuscular mycorrhizal |
| | fungi aseptic in vitro |
| U.S. Pat. No. 6,746,696 | Triterpene compositions and methods for use |
| | thereof |
| U.S. Pat. No. 6,719,488 | Soil pf value measuring method, and irrigation |
| | control method and irrigation control device |
| U.S. Pat. No. 6,689,398 | Triterpene compositions and methods for use |
| | thereof |
| U.S. Pat. No. 6,544,789 | Phosphorus-controllable recombinant |
| | expression of polypeptides in plants |
| U.S. Pat. No. 6,508,033 | Self contained fully automated robotic crop |
| | production facility |
| U.S. Pat. No. 6,444,233 | Triterpene compositions and methods for use |
| | thereof |
| U.S. Pat. No. 6,365,406 | Enhancers of net photosynthesis and methods |
| | of enhancing net photosynthesis |
| U.S. Pat. No. 6,324,785 | Process for harvesting organic compounds |
| | from plant roots |
| U.S. Pat. No. 6,314,675 | Air culture system comprising a management |
| | system |
| U.S. Pat. No. 6,276,089 | Chamber for aeroponic culture |
| U.S. Pat. No. 6,270,809 | Nutritional supplements |
| U.S. Pat. No. 6,243,987 | Self contained fully automated robotic crop |
| | production facility |
| U.S. Pat. No. 6,219,966 | Container for hydroponic culture and method |
| | for making same |
| U.S. Pat. No. 6,096,546 | Methods for recovering polypeptides from |
| | plants and portions thereof |
| U.S. Pat. No. 6,080,222 | Organic liquid nutrition source for plants and |
| | manufacturing method for same |
| U.S. Pat. No. 6,070,358 | Seed germination system |
| U.S. Pat. No. 6,065,245 | Integrated aquaculture-hydroponics systems: |
| | nutrient dynamics and designer |
| | diet development |
| U.S. Pat. No. 6,021,602 | Modular structure for aeroponic cultivations |
| U.S. Pat. No. 6,000,173 | Hydroponic growing station with intermittent |
| | nutrient supply |
| U.S. Pat. No. 5,937,575 | Aeroponic growth system with nutrient fog |
| | stabilization |
| U.S. Pat. No. 5,918,416 | Aeroponic plant growth apparatus and method |
| U.S. Pat. No. 5,876,484 | Method for removing soluble metals from an |
| | aqueous phase |
| D402,668 | Aeroponic plant grower with plant support |
| D402,296 | Aeroponic plant grower |
| D402,230 | Support for supporting plants for aeroponic |
| | treatment |
| D397,280 | Aeroponic plant grower housing cover with |
| | seed support screens |
| U.S. Pat. No. 5,724,768 | Aeroponic plant growth apparatus and method |
| U.S. Pat. No. 5,648,598 | Ornamental character of scented geraniums |
| | by genetic transformation |
| U.S. Pat. No. 5,589,437 | Method of using 5-hydroxybenzimidazole |
| | compounds for reducing transpiration in |
| | plants |
| U.S. Pat. No. 5,501,037 | Hydroponics process and device |
| U.S. Pat. No. 5,393,426 | Method for removing soluble metals from an |
| | aqueous phase |
| U.S. Pat. No. 5,300,260 | Fog generator |
| U.S. Pat. No. 5,136,804 | System for germination, propagation and |
| | growing plants in ultrasonic-fog |
| | conditions (aeroponics) |
| U.S. Pat. No. 5,096,481 | Sheared roots as a VA-mycorrhizal inoculum |
| | and methods for enhancing plant growth |
| U.S. Pat. No. 4,869,019 | Aeroponic apparatus |
| U.S. Pat. No. 4,813,176 | Aeroponic apparatus |
| U.S. Pat. No. 4,721,250 | Method and apparatus for effecting control of |
| | atmospheric temperature and humidity |
| U.S. Pat. No. 4,669,217 | Plant propagation system and apparatus |
| U.S. Pat. No. 4,584,791 | Soiless agricultural system and components |
| | therefore |
| U.S. Pat. No. 4,514,930 | Method and apparatus for aeroponic |
| | propagation of plants |
| U.S. Pat. No. 4,332,105 | Apparatus and method for plant growth in |
| | aeroponic conditions |

The aforementioned description of related art, including information disclosed under 37 CFR 1.97 and 1.98, encompasses prior uses or conjunctive uses of methods of traditional agriculture, hydroponic, aquaponic, and aeroponic systems. The specification and drawings describe an invention vastly superior and differentiable to an extent that the only common trait is the used name of traditional agriculture, hydroponic, aquaponic, and aeroponic systems. Otherwise the benefits will be evidently clear after close examination by a person sufficiently trained within this field of knowledge.

The main objective of this invention is to allow for the movement and free range mobility of the component(s) used in agriculture or cultivation and the coupling and un-coupling of the component. This invention is in contrast to existing traditional agriculture, hydroponic, aquaponic, and aeroponic systems that rely on components, such as containers that house the plants, to remain stationary or operate with limited mobility. Existing traditional agriculture, hydroponic, aquaponic, and aeroponic systems do not allow for the movement of the apparatus that contains the plant or organism and require workers to seed, transplant, care, and harvest the plant or organism at a specific point. The complex aforementioned system does not address all the needs associated with the production of a plant or an organism and carries an increased cost associated with development, manufacturing, the final point of purchase, additional equipment needed for the production of a plant or an organism, a decrease of performance, and a decrease in efficiency. While the aforementioned is stated in simplified terms, and may not describe all objectives and advantages in full, the specifications in its entirety encompasses a more thorough and detailed explanation of the objectives and advantages.

### BRIEF SUMMARY OF THE INVENTION

An apparatus comprising of a component used in agriculture or cultivation, such as a container that is sufficient for the growth of plants or an organism, that contains a movement device, such as wheels, rollers, bearings etc. . . . , to assist in the free range mobility of the component, such as a container and the container's contents. Further the apparatus comprising of a component used in agriculture or cultivation, such as container that is sufficient for the growth of plants or an organism, that contains a movement device to assist in the free range mobility of the component may also contain connection devices, such as quick connected couplers with internal valves, fittings, tubing etc. . . . , to couple and un-couple the components if multiple components are used in conjunction with one another. And links to connect components if one component is removed from a series of components, i.e. an aeroponic system that supplies each container with drain tubing that is interconnected to each container in a series, parallel, or loop and drains to a single point. The term “organism” should not be construed as a limiting term but rather as a broad term for any portion of an organism, such as tissue, or an organism in the dormant state, such as a seed, or an organism that may be a part of a colony, such as a colony of bacteria or algae, or fungi, or anything that may be termed an organism or is comparable to an organism in nature, such as viruses and protocells. The term “component” used in agriculture or cultivation should not be construed as a limiting term but rather as a broad term for any component that may be used in agriculture or cultivation such as a container, reservoir, pump, or any physical item. The term “agriculture” or “cultivation” should not be construed as a limiting term but rather as a broad term for any cultivation, incubation or growth of an organism. The term “movement device” should not be construed as a limiting term but rather as a broad term for any devices that can assist in the movement of a component. The term “connection device” should not be construed as a limiting term but rather as a broad term for any devices that can connect or disconnect components. It should also be noted that the mobility and connectivity of all components associated with agriculture or cultivation production should be included when typically such component has been traditionally stationary, i.e. a structure that contains and has mounts for lighting and cooling equipment that remains stationary or a pumping station that remains stationary.

This method and apparatus increases efficiency. This is achieved by allowing the free range mobility of the container and the container's contents and the coupling and un-coupling of the containers. The benefit of this is to allow the process to achieve an assembly line approach rather than a stationary single point approach. For instance if this apparatus was used for the cultivation of plants in an aeroponics system with a single supply tank for the nutrient solution that supplied multiple containers used to grow the plants in and each container was interconnected with supply lines that could couple and un-couple a single container an assembly line approach, one in which steps are pragmatically accomplished at specific area, could be achieved and if a single component or container needed to be removed such removal could be accomplished with minimal inconveniences.

### BRIEF DESCRIPTION OF THE SEVERAL VIEWS OF THE DRAWING(S)

FIG. 1. is a front angle view of a model apparatus for the explanation of the invention;

FIG. 2. is a front bottom view of a model apparatus for the explanation of the invention;

FIG. 3. is a side view of a model apparatus for the explanation of the invention; and

FIG. 4. is a front top view of a model apparatus for the explanation of the invention.

### DETAILED DESCRIPTION OF THE INVENTION

A method and/or an apparatus comprising of a component used in agriculture or cultivation, such as a container that is sufficient for the growth of plants or an organism, that contains a movement device, such as wheels, rollers, bearings etc. . . . , to assist in the free range mobility of the component, such as a container and the container's contents. Further the apparatus comprising of a component used in agriculture or cultivation, such as container that is sufficient for the growth of plants or an organism, that contains a movement device to assist in the free range mobility of the component may also contain connection devices, such as quick connected couplers with internal valves, fittings, tubing etc. . . . , to couple and un-couple the components if multiple components are used in conjunction with one another. And links to connect components if one component is removed from a series of components, i.e. an aeroponic system that supplies each container with drain tubing that is interconnected to each container in a series, parallel, or loop and drains to a single point. The term “organism” should not be construed as a limiting term but rather as a broad term for any portion of an organism, such as tissue, or an organism in the dormant state, such as a seed, or an organism that may be a part of a colony, such as a colony of bacteria or algae, or fungi, or anything that may be termed an organism or is comparable to an organism in nature, such as viruses and protocells. The term “component” used in agriculture or cultivation should not be construed as a limiting term but rather as a broad term for any component that may be used in agriculture or cultivation such as a container, reservoir, pump, or any physical item. The term “agriculture” or “cultivation” should not be construed as a limiting term but rather as a broad term for any cultivation, incubation or growth of an organism. The term “movement device” should not be construed as a limiting term but rather as a broad term for any devices that can assist in the movement of a component. The term “connection device” should not be construed as a limiting term but rather as a broad term for any devices that can connect or disconnect components. It should also be noted that the mobility and connectivity of all components associated with agriculture or cultivation production should be included when typically such component has been traditionally stationary, i.e. a structure that contains and has mounts for lighting and cooling equipment that remains stationary or a pumping station that remains stationary.

This apparatus increases efficiency. This is achieved by allowing the free range mobility of the container and the container's contents and the coupling and un-coupling of the containers. The benefit of this is to allow the process to achieve an assembly line approach rather than a stationary single point approach. For instance if this apparatus was used for the cultivation of plants in an aeroponics system with a single supply tank for the nutrient solution that supplied multiple containers used to grow the plants in and each container was interconnected with supply lines that could couple and un-couple a single container an assembly line approach, one in which steps are pragmatically accomplished at specific area, could be achieved and if a single component or container needed to be removed such removal could be accomplished with minimal inconveniences.

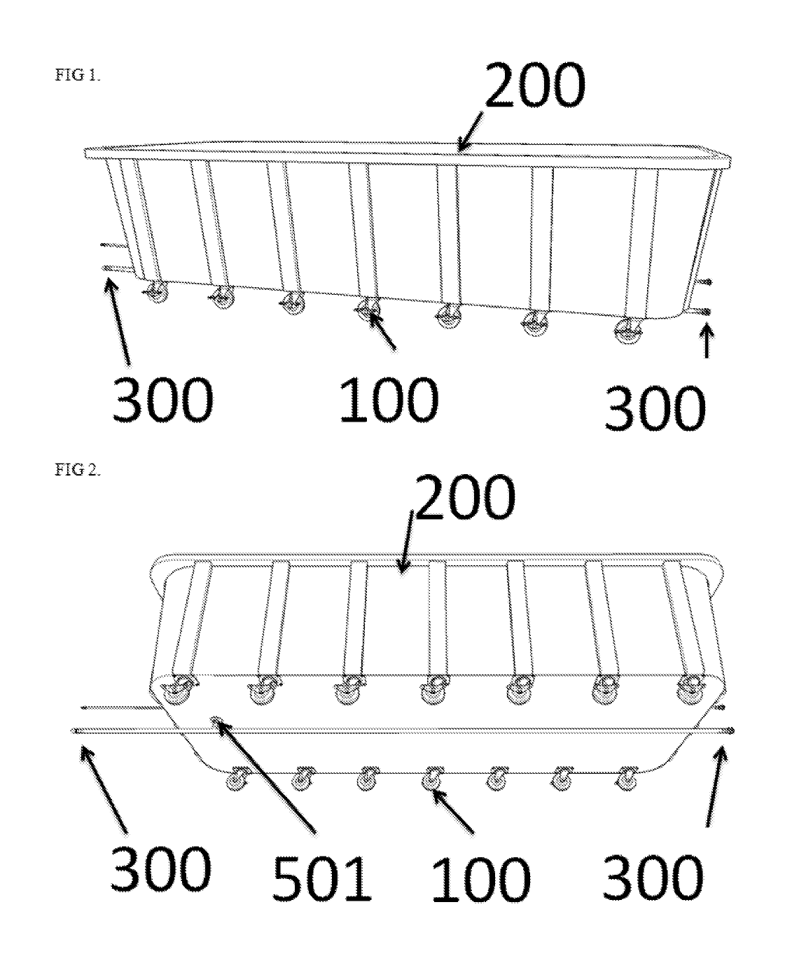

Referring to the invention explained in more detail, in FIG. 1. there is shown model apparatus for the explanation of the invention, consisting of a movement device 100, a container 200, and a connection device 300. In this model apparatus the implementation is that of which the movement device 100 is mounted directly to the container 200. The connection device 300 is shown on both sides on the container 200.

Now in further detail, still referring to FIG. 1., in this model apparatus the movement device 100 is implemented as a caster wheel but could be any device capable of movement, such as bearings or rollers. In this model apparatus the container 200 is a component used in agriculture or cultivation, in this case it is implemented as a rectangular container but could be any component used in agriculture or cultivation, such as a pump or reservoir. In this model apparatus the connection device 300 is shown on both side and is implemented as a quick connector but could be any device capable of connecting and disconnecting, such as fittings and tubing or valves and connectors. The connection device 300 should be implemented in a way that the container 200, in multiples, could be linked together in a series. This depiction is a representation of a implementation of the invention and should not be construed as limiting or all encompassing.

Referring to the invention explained in more detail, in FIG. 2. there is shown model apparatus for the explanation of the invention, consisting of a movement device 100, a container 200, and a connection device 300. In this model apparatus the implementation is that of which the movement device 100 is mounted directly to the container 200. The connection device 300 is shown on both sides on the container 200. A bulkhead 501 connects through the container 200.

Now in further detail, still referring to FIG. 2., in this model apparatus the movement device 100 is implemented as a caster wheel but could be any device capable of movement, such as bearings or rollers. In this model apparatus the container 200 is a component used in agriculture or cultivation, in this case it is implemented as a rectangular container but could be any component used in agriculture or cultivation, such as a pump or reservoir. In this model apparatus the connection device 300 is shown on both side and is implemented as a quick connector but could be any device capable of connecting and disconnecting, such as fittings and tubing or valves and connectors. The connection device 300 should be implemented in a way that the container 200, in multiples, could be linked together in a series. The bulkhead 501 connects through the container 200 and in this implementation the bulkhead 501 is a bulkhead fitting but could be any fitting or device that is able to securely connect to the container 200. This depiction is a representation of a implementation of the invention and should not be construed as limiting or all encompassing.

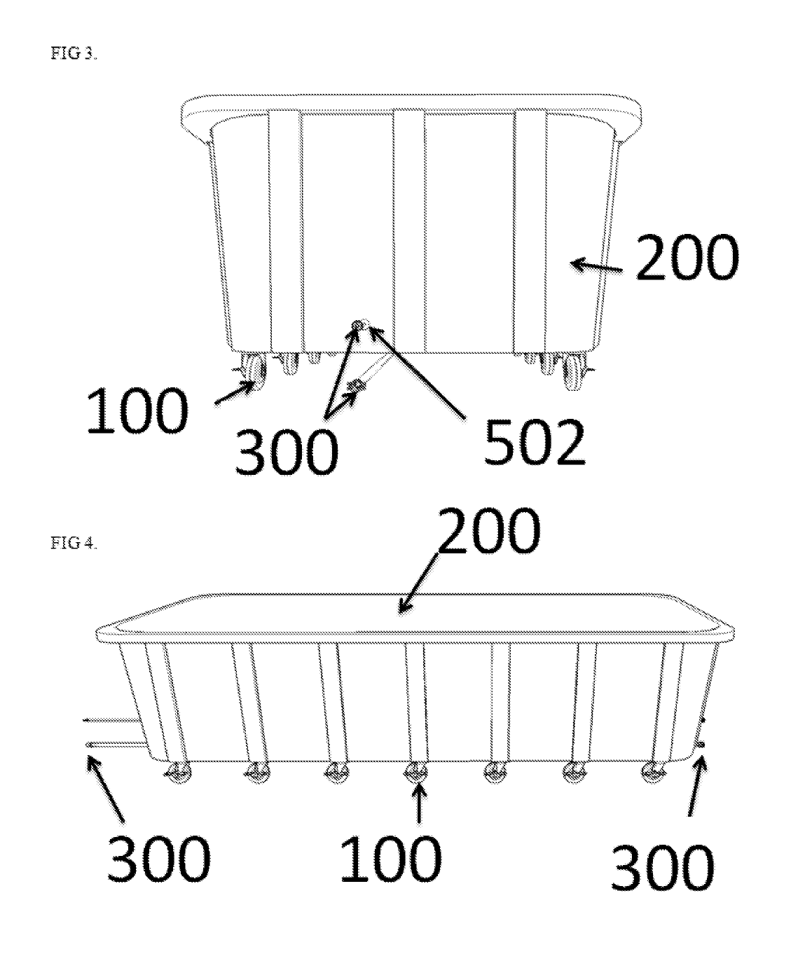

Referring to the invention explained in more detail, in FIG. 3. there is shown model apparatus for the explanation of the invention, consisting of a movement device 100, a container 200, and a connection device 300. In this model apparatus the implementation is that of which the movement device 100 is mounted directly to the container 200. The connection device 300 is shown on both sides on the container 200. A grommet 502 connects through the container 200.

Now in further detail, still referring to FIG. 3., in this model apparatus the movement device 100 is implemented as a caster wheel but could be any device capable of movement, such as bearings or rollers. In this model apparatus the container 200 is a component used in agriculture or cultivation, in this case it is implemented as a rectangular container but could be any component used in agriculture or cultivation, such as a pump or reservoir. In this model apparatus the connection device 300 is shown on both side and is implemented as a quick connector but could be any device capable of connecting and disconnecting, such as fittings and tubing or valves and connectors. The connection device 300 should be implemented in a way that the container 200, in multiples, could be linked together in a series. The grommet 502 connects through the container 200 and in this implementation the grommet 502 is a grommet fitting but could be any fitting or device that is able to securely connecting through container 200. This depiction is a representation of a implementation of the invention and should not be construed as limiting or all encompassing.

Referring to the invention explained in more detail, in FIG. 4. there is shown model apparatus for the explanation of the invention, consisting of a movement device 100, a container 200, and a connection device 300. In this model apparatus the implementation is that of which the movement device 100 is mounted directly to the container 200. The connection device 300 is shown on both sides on the container 200.

Now in further detail, still referring to FIG. 4., in this model apparatus the movement device 100 is implemented as a caster wheel but could be any device capable of movement, such as bearings or rollers. In this model apparatus the container 200 is a component used in agriculture or cultivation, in this case it is implemented as a rectangular container but could be any component used in agriculture or cultivation, such as a pump or reservoir. In this model apparatus the connection device 300 is shown on both side and is implemented as a quick connector but could be any device capable of connecting and disconnecting, such as fittings and tubing or valves and connectors. The connection device 300 should be implemented in a way that the container 200, in multiples, could be linked together in a series. This depiction is a representation of a implementation of the invention and should not be construed as limiting or all encompassing.

This apparatus could be constructed in various ways and in incremental steps or by an apparatus of varying components, materials and be a multitude of sizes and shapes. For instance the apparatus could be constructed by mounting caster wheels directly to a container or a frame could be constructed with caster wheels mounted to the frame and a container that sits on the frame. Both accomplish the same task. Further quick disconnects could be used in a variety of ways and quick disconnects come in a variety of fashions, but simply using tubing and connections could accomplish the same task, what is important in all instances is that there is an increase mobility.

The advantages of the aforementioned invention include, without limitation, an apparatus that allows for agriculture or cultivation to become mobile and not be restricted to stationary components. This method increases the efficiency of the cultivation process through increasing the mobility of various components used in the cultivation process and by increasing the ease of connecting and disconnecting components. Through the use of this invention a substantial positive impact is derived due to a reduction in operating costs, ease of use, an increase in efficiency, and an increase in profitability.

### Operation of Preferred Embodiment

In broad embodiment, the present invention is capable of allowing normally stationary components of agriculture or cultivation, i.e. a container used to house and cultivate plants, to become mobile and to be easily connected or disconnected to additional components. The best practice of operation is to mount wheels, such as caster wheels, directly to a container or component. Factor such as water leakage or structural stability should be addressed as needed. Quick connectors with internal shut off valves should be used, ideally two sets connectors should be used for any single operation to allow for a series of containers or components to be connected and disconnected as needed.

### Description of Additional Embodiment

In an additional embodiment, the present invention is capable of allowing normally stationary components of agriculture or cultivation such as structures that equipment is mounted to, such as lights or fans, to become mobile and to be easily connected or disconnected to additional structures.

### Operation of Additional Embodiment

The best practice of operation is to mount wheels, such as caster wheels, directly to the structure. Connectors for electrical or conduit connectors for cooling should be used, ideally two sets connectors should be used for any single operation to allow for a series of structures to be connected and disconnected as needed.

### Conclusion, Ramification, and Scope

In the broad embodiment the present invention allows for components that traditionally are stationary or have limited movement to become mobile and easily connected and disconnected. Further the present invention must not necessarily be used only with caster wheels and quick disconnections but could utilize a varying combination of devices to assist in mobility and connections to produce desired results and may be that of which the placement or implementation or combination may vary as is necessary to achieve the desired function of the solution, but itself is not wheels or connectors.

The aforementioned written description of the present invention enables one in the given technical field and of ordinary skill to recreate what is stated as the best mode and should therefore be stated that those of ordinary skill would comprehend and grasp alterations, combinations of alterations and variations, and parallel incorporations of specific embodiments, examples and methods. Therefore the aforementioned written and drawn description of the present invention should not be limited by the described embodiment, examples and methods but should be encompassed by the scope and spirit of any and all embodiments, examples and methods.

### Sequence Listing or Program

Not applicable

1. The invention of mobile agriculture comprising:
A. A movement device or movement devices, such as wheels, or rollers, or bearings etc. . . . , to assist in the free range mobility of a component used in agriculture or cultivation, such as a container, or pump, or reservoir etc. . . . ; and
B. A connection device or connection devices, such as quick connect couplers with internal valves, or fittings, or tubing etc. . . . , to couple and un-couple the component used in agriculture or cultivation, such as a container, or pump, or reservoir etc. . . . if multiple components are used in conjunction with one another.

2. The invention of claim 1 further comprising of a movement device or movement devices to assist in the free range mobility of any component used in agriculture or cultivation wherein the movement device or movement devices is mounted directly to the component, or the component is attached to a frame or housing that contains the movement device or movement devices, or any combination where the movement device or movement devices is mounted directly to the component, or the component is attached to a frame or housing that contains the movement device or movement devices.

3. The invention of claim 2 wherein any component of agriculture or cultivation is attached to or utilizes a movement device or movement devices to assist in the free range mobility.

4. The invention of claim 3 wherein a connection device or connection devices to couple and un-couple the component used in agriculture or cultivation are connected through the component, for example utilizing a grommet in which a pipe passes through, or are connected to the component, for example utilizing a wiring harness, or are connected utilizing fittings or devices that intermediate the connection, for example a bulkhead fitting. Any examples are not exclusive but used to enhance the description.

5. The invention of claim 4 wherein a connection device or connection devices to couple and un-couple the component used in agriculture or cultivation are of a variety of sizes, shapes, materials, and form and are meant to represent any device that is capable of connecting or disconnecting.

6. The invention of claim 5 wherein any component of agriculture or cultivation is attached to or utilizes a connection device or connection devices to connect and disconnect components.

7. The invention of claim 6 wherein a link to connect a removed component used in agriculture or cultivation is utilized and links to connect components used in agriculture or cultivation if one or more components are removed.

8. The invention of claim 7 wherein a movement device or movement devices utilizes a motor, or engine, or gear, or any such device or devices capable of providing assistance in transporting a component used in agriculture or cultivation or completely capable of transporting a component used in agriculture or cultivation.

9. The invention of claim 8 wherein a movement device or movement devices to assist in the free range mobility of any component used in agriculture or cultivation is automated, or is controlled via a computer or similar device.

10. The invention of claim 9 wherein a movement device or movement devices to assist in the free range mobility of any component used in agriculture or cultivation is controlled remotely through or utilizes; any method of communication, or data transmission, or any communication and data transmission.

11. The invention of claim 10 wherein a connection device or connection devices utilizes a motor, or engine, or gear, or any such device or devices capable of providing assistance in connecting or disconnecting a component used in agriculture or cultivation or completely capable of connecting or disconnecting a component used in agriculture or cultivation.

12. The invention of claim 11 wherein a connection device or connection devices used in the connecting or disconnecting of any component used in agriculture or cultivation is automated, or is controlled via a computer or similar device.

13. The invention of claim 12 wherein a connection device or connection devices used in the connecting or disconnecting of any component used in agriculture or cultivation is controlled remotely through or utilizes; any method of communication, or data transmission, or any communication and data transmission.

14. The invention of mobile agriculture comprising of a movement device or movement devices to assist in the free range mobility of a component used in agriculture or cultivation.

15. The invention of claim 14 further comprising of a movement device or movement devices to assist in the free range mobility of any component used in agriculture or cultivation wherein the movement device or movement devices is mounted directly to the component, or the component is attached to a frame or housing that contains the movement device or movement devices, or any combination where the movement device or movement devices is mounted directly to the component, or the component is attached to a frame or housing that contains the movement device or movement devices.

16. The invention of claim 15 wherein any component of agriculture or cultivation is attached to or utilizes a movement device or movement devices to assist in the free range mobility.

17. The invention of claim 16 wherein a movement device or movement devices utilizes a motor, or engine, or gear, or any such device or devices capable of providing assistance transporting a component used in agriculture or cultivation or completely capable of transporting a component used in agriculture or cultivation.

18. The invention of claim 17 wherein a movement device or movement devices to assist in the free range mobility of any component used in agriculture or cultivation is automated, or is controlled via a computer or similar device.

19. The invention of claim 18 wherein a movement device or movement devices to assist in the free range mobility of any component used in agriculture or cultivation is controlled remotely through or utilizes; any method of communication, or data transmission, or any communication and data transmission.

20. The invention of mobile agriculture wherein a component of agriculture or cultivation that is typically stationary or has limited movement is no longer stationary or no longer has limited movement and has the ability to connect and disconnect as needed, accomplished by utilizing any device or devices capable of producing the desired results.
